(19) United States
(12) Patent Application Publication
(10) Pub. No.: US 2014/0352438 A1
(43) Pub. Date: Dec. 4, 2014

(54) DEVICE FOR ULTRASONIC INSPECTION

(71) Applicant: General Electric Company, Schenectady, NY (US)

(72) Inventors: Luca Scaccabarozzi, Cologne (DE); York Oberdoerfer, Langenfeld (DE)

(73) Assignee: General Electric Company, Schenectady, NY (US)

(21) Appl. No.: 13/903,597

(22) Filed: May 28, 2013

(51) Int. Cl. G01N 29/24; G01N 29/04

(52) U.S. Cl. CPC G01N 29/2437; G01N 29/043; G01N 2291/0422; G01N 2291/0421
USPC 73/632

(57) ABSTRACT

This disclosure describes embodiments of a probe device that can replace the multiple probes now required to perform inspection of hollow targets. These embodiments can generate acoustic waves as both shear waves and compression waves. Moreover, configurations of the probe devices below can direct the acoustic waves across an angular range that accommodates for the position of potential anomalies in the hollow target.

### BACKGROUND OF THE INVENTION

The subject matter disclosed herein relates to ultrasonic inspection and, in certain embodiments, to a device for use to perform ultrasonic inspection of targets.

Ultrasonic testing employs a probe device to detect anomalies that are not readily apparent during visual inspection of a target. This probe device can incorporate one or more transducers that generate acoustic waves into the target in response to stimuli, e.g., electrical waveform pulses. The stimuli energize the transducers, which in turn emit the acoustic waves in the form of shear waves and/or compression waves. The probe device often includes a piece of material, or “wedge,” that covers the transducer elements. The wedge acts as a barrier to protect the transducers from damage and as a medium to conduct the acoustic waves from the transducers to the surface of the target.

The number of transducers can determine operation of the probe device. For example, probe devices that utilize a single transducer can emit acoustic waves in a single, fixed direction. On the other hand, probe devices that deploy multiple transducers can implement phased-array ultrasonics. These types of probe devices can dynamically change the direction and focus of acoustic waves that emit from the transducers.

Inspection of the target may need to use acoustic waves of a specific form to detect certain types of anomalies. For example, compression waves are useful to detect volumetric flaws (e.g., voids, inclusions, etc.), which are found inside of the material of the target. Shear waves can help identify cracks (e.g., transversal cracks) and notches (e.g., longitudinal notches) that develop on the outer surface of the target. In other examples, “quasi” surface waves and/or waves having a very high steering angle (e.g., about 70° or greater) are useful to detect internal cracks.

All three types of anomalies can occur in hollow targets (e.g., pipes, tubes, axles, etc). Unfortunately, neither probe devices with a single transducer nor probe devices with multiple transducers can generate shear waves and compression waves as well as accommodate for geometry of the hollow target. As a result, ultrasonic testing of hollow targets often utilizes more than one probe device and, more likely, at least three probe devices that are different from one another. In some examples, the inspection may require at least five different probe devices to generate waves in directions (e.g., forward, backware, clockwise, and counterclockwise) appropriate detection of transversal crack and longitudinal notch.

The discussion above is merely provided for general background information and is not intended to be used as an aid in determining the scope of the claimed subject matter.

### BRIEF DESCRIPTION OF THE INVENTION

This disclosure describes embodiments of a probe device that can replace the multiple probes now required to detect volumetric flaws and longitudinal notches in hollow targets. These embodiments can generate acoustic waves as both shear waves and compression waves. Moreover, configurations of the probe devices below can direct the acoustic waves across an angular range that accommodates for the position of potential anomalies in the hollow target.

This disclosure describes, in one embodiment, an ultrasonic probe that comprises a base component and a transducer assembly disposed on the base component. The transducer assembly comprises a first transducer array and a second transducer array that reside on either side of a centerplane of the base component. The ultrasonic probe also comprises a wedge component coupled with the base component in position to receive acoustic waves from the first transducer array and the second transducer array. In one example, the wedge component has an outer surface with a non-linear shape.

This disclosure also describes, in one embodiment, a probe that comprises a base component that has a first surface and a centerplane. The probe also comprises a first transducer element disposed on the first surface proximate the centerplane and at a first transducer angle relative to a plane that is tangent to the first surface and perpendicular to the centerplane. The probe further comprises a second transducer element adjacent to the first transducer and disposed on the first surface at a second transducer angle relative to the plane and perpendicular to the centerplane. In one example, the first transducer angle is different from the second transducer angle.

This disclosure further describes, in one embodiment, a system that comprises a probe device comprising a base component with a centerplane, a first transducer array disposed on the base component on a first side of the centerplane, and a second transducer array disposed on the base component on a second side of the centerplane. The probe device also comprises a wedge component mounted to the base component in position to receive acoustic waves from the first transducer array and the second transducer array. The system also comprises a test instrument adapted to exchange signals that energize the first transducer array and the second transducer array to generate the acoustic waves. In one example, the first transducer array, the second transducer array, and an outer surface of the wedge component have a profile with a non-linear shape.

This brief description of the invention is intended only to provide a brief overview of the subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a perspective view of an exemplary embodiment of a probe device that can generate compression waves and shear waves to interrogate a target;

FIG. 2 depicts the probe device of FIG. 1 as part of an inspection system;

FIG. 3 depicts a side, elevation view of the probe device of FIG. 1;

FIG. 4 depicts a side, elevation view of the probe device of FIG. 1 in position to interrogate the target;

FIG. 5 depicts a side, elevation view of another exemplary embodiment of a probe device that can generate compression waves and shear waves to interrogate a target;

FIG. 6 depicts a detail view of the probe device of FIG. 5 to illustrate one configuration of transducer elements;

FIG. 7 depicts a plan view of the probe device of FIG. 5; and

FIG. 8 depicts a perspective view of an example of a wedge component for use on a probe device, e.g., probe devices of FIGS. 1, 2, 3, 4, 5, 6, and 7.

### DETAILED DESCRIPTION OF THE INVENTION

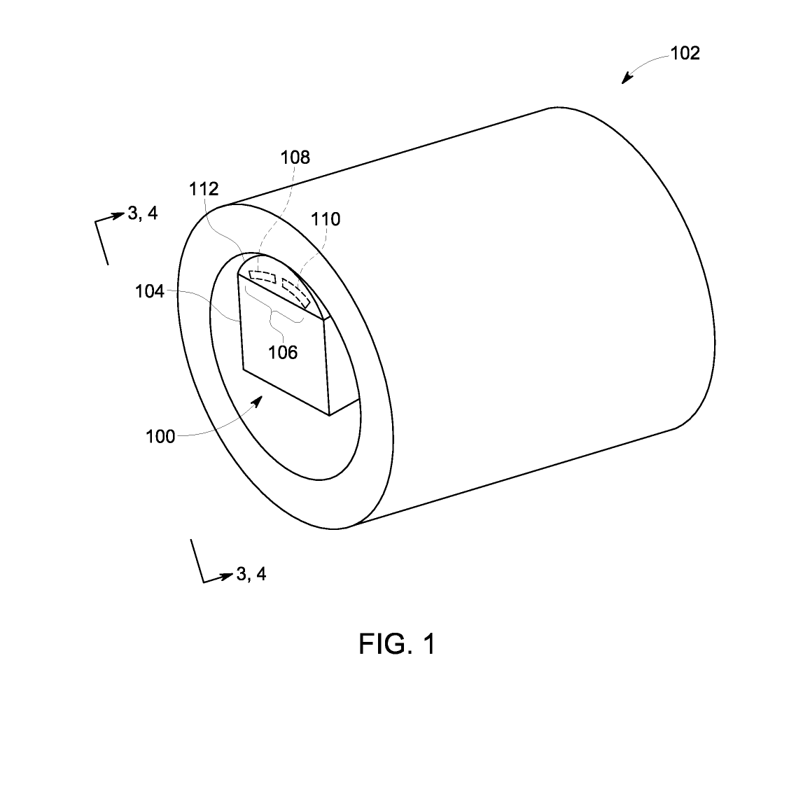

FIG. 1 illustrates a perspective view of an exemplary embodiment of a probe device 100 that can generate acoustic waves to perform non-destructive testing. The probe device 100 is in position to inspect a target 102. Examples of the target 102 include items with features that are generally cylindrical in shape, e.g., found on tubes, pipes, axles, etc., although this disclosure contemplates use of the probe device to inspect items of any particular shape. The probe device 100 has a body component 104 and a transducer assembly 106 with one or more transducer arrays (e.g., a first transducer array 108 and a second transducer array 110), shown generally in phantom lines. The probe device 100 also includes a wedge component 112 that is in position to conduct acoustic waves from the transducer arrays 108, 110 into the target 102.

During operation, embodiments of the probe device 100 can energize transducers in the transducer arrays 108, 110 to detect and/or to identify anomalies found on the target 102. These anomalies include surface anomalies (e.g., longitudinal notches) and interior anomalies (e.g., volumetric flaws). The embodiments utilize geometry for the transducer arrays 108, 110 and the wedge component 112 that afford the probe device 100 with the ability to direct acoustic waves over a wide angular range. This range permits inspection of targets that would normally require multiple different probes of conventional design to generate acoustic waves radially, clockwise, and counterclockwise with a single probe (e.g., probe device 100).

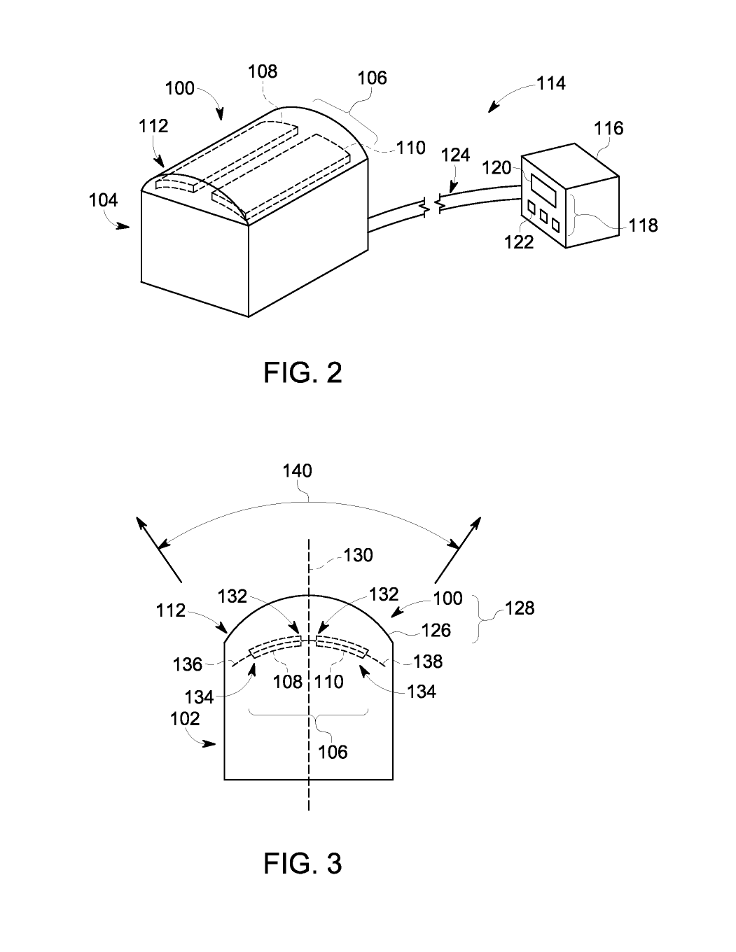

In FIG. 2, the probe device 100 is shown as part of an inspection system 114 with a test instrument 116 that has an interface 118 with a display 120 and controls 122. The test instrument 116 exchanges signals with the probe device 100, e.g., via a cable 124. These signals can energize the transducer arrays 108, 110 to transmit acoustic waves. Implementation of the probe device 100 uses these acoustic waves to identify the anomalies (e.g., cracks, voids, etc.) in the target.

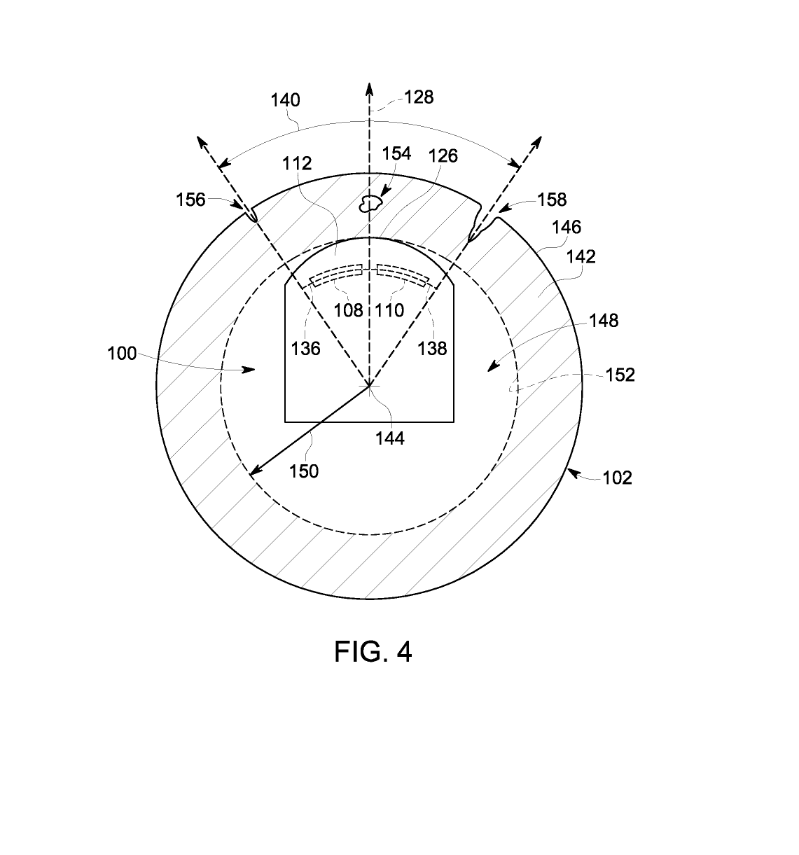

FIGS. 3 and 4 depict a side, elevation view of the probe device 100 taken at line 3, 4-3, 4 of FIG. 1. In FIG. 3, the target 102 is removed for clarity. The wedge component 112 has an outer surface 126 with a non-planar shape 128. The probe device 100 has a centerplane 130 that bisects the body component 102 and the wedge component 112. The transducer arrays 108, 110 reside on either side and are spaced apart from the centerplane 130. This configuration of the transducer arrays 108, 110 can form a substantially symmetric and/or mirror-image structure, wherein the transducer array 108 has the same arrangement of transducers as the transducer array 110. The transducer arrays 108, 110 have a first end 132 proximate the centerplane 130 and a second end 134 spaced apart from first end 132. In one embodiment, the transducer arrays 108, 110 assume a profile (e.g., a first profile 136 and a second profile 138), generally denoted in phantom lines. Operation of the probe device 100 generates acoustic waves in various directions across an angular range, generally identified by the numeral 140.

The profiles 136, 138 of the transducer arrays 108, 110 can assume both curvilinear shapes (e.g., an arc and/or arcuate shape) and linear shapes (e.g., a straight line). These shapes position the transducer arrays 108, 110 in a manner to expand the angular range 140, e.g., by allowing the acoustic waves to reach the outer extent of the angular range 140 with lower angles for steering of the acoustic waves. The profiles 136, 138 define the position of the first end 132 and the second end 134 of the transducer arrays 108, 110. In the diagram of FIG. 3, for example, the profiles 136, 138 have a generally arcuate form that locates the second end 134 below the first end 132 relative to (and/or along) the centerplane 130.

FIG. 4 depicts the probe device 100 with the target 102. The target 102 forms an annular ring 142 about a longitudinal axis 144. The annular ring 142 has an exterior surface 146 and a central bore 148 with a radius 150 that defines an interior surface 152. The target 102 is shown with various anomalies (e.g., a first anomaly 154, a second anomaly 156, and a third anomaly 158). Examples of the first anomaly 154 include flaws, also referred to as volumetric flaws, that propagate inside of the material structure of the annular ring 142. The anomalies 156, 158 represent flaws (e.g., cracks and/or notches) that are often referred to as longitudinal flaws because the resulting flaw may extend along the longitudinal axis 144 in the exterior surface 146.

Embodiments of the probe device 100 assign the shape and/or configuration of the wedge component 112 and the transducer arrays 108, 110 to maximize the size and/or scope of the angular range 140. The wider range allows the probe device 100 to direct, or steer, acoustic waves at the anomalies 156, 158 from a fixed location. In one embodiment, the non-linear shape 128 of the wedge component 112 conforms with a surface (e.g., interior surface 152) on the target 102. Examples of these shapes include annular and/or semi-annular shapes, as shown in FIG. 3, as well as other shapes as desired and/or as dictated by one or more surfaces of the target 102. In one embodiment, the shape of the wedge component 112 has a radius that is the same and/or equal to the radius 150 of the target 102.

During operation, the probe device 100 inserts into the central bore 148 to direct acoustic waves from the transducer arrays 108, 110 into the annular ring 142. In one implementation, fluid (e.g., oil) can be dispersed between the outer surface 124 of the wedge component 104 and the interior surface 152 of the central bore 148. The fluid lubricates the surfaces to prevent scratches and/or other damage to either the probe device 100 or the target 102. In one example, the fluid acts as a medium favorable for conducting and/or coupling acoustic waves from the probe device 100 to the target 102.

The probe device 100 can operate in different operating modes to identify the different anomalies 154, 156, 158. These operating modes correspond to operation of the transducer arrays 108, 110 to generate compression waves and/or shear waves. For compression waves, the probe device 100 enters a transmit/receive (T/R) mode that operates one of the transducer arrays 108, 110 to transmit acoustic waves into the annular ring 138 and one of the transducer arrays 108, 110 receives acoustic waves that reflect back to the probe device 100 from the annular ring 142. The T/R mode is useful for the probe device 100 to identify volumetric flaws (e.g., the first anomaly 154) found in the interior structure of the annular ring 142. For shear waves, the probe device 100 enters a pulse-echo (PE) mode that operates the transducer array 108 and the transducer array 110 independent from one another to both transmit and receive acoustic waves. The PE mode is useful for the probe device 100 to identify the second anomaly 156 and the third anomaly 158. Moreover, configurations of the probe device 100 for phased array ultrasonics can further enhance operation of the T/R mode and the PE mode. In the T/R mode, for example, phased array configurations of the probe device 100 can dynamically change the focusing depth of the beam to increase the energy of the acoustic waves along the thickness of the target 102. When utilized in the PE mode, phased array configurations can dynamically change the steering angle of the beam to increase the probability of detection (POD) and to cover wider portions of the exterior surface 146 of the annular ring 142.

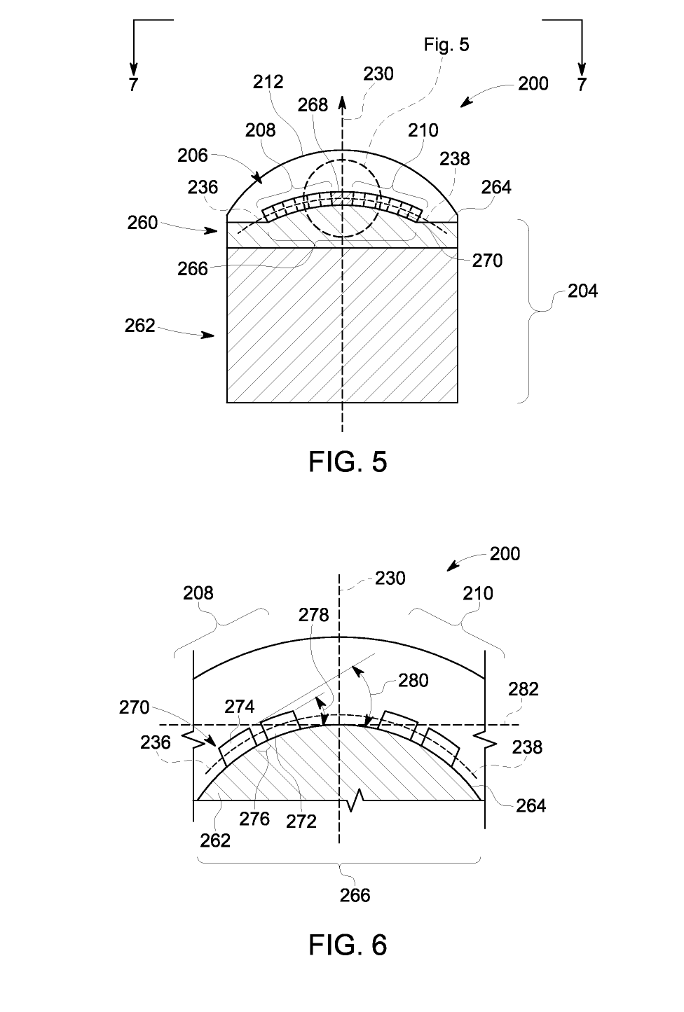

FIG. 5 illustrates a cross-section of an exemplary embodiment of a probe device 200 with features to inspect a target (e.g., target 102 of FIGS. 1 and 4) as contemplated herein. In the example of FIG. 5, the base component 204 includes a damping component 260 and a housing component 262. The damping component 260 has an upper surface 264 with a transducer section 266 proximate the centerplane 230. The transducer assembly 206 includes a barrier component 268 that separates the transducer arrays 208, 210. In one example, the transducer arrays 208, 210 include one or more transducer elements 270, which are disposed in the transducer section 266 of the damping component 260.

Materials for use in the probe device 200 can facilitate inspection, e.g., by avoiding energy lose in the acoustic waves. The transducer elements 270 can comprise, in whole or in part, piezoelectric materials. These types of materials include, for example, mataniobate, piezoelectric crystals, and any combinations and derivations thereof. In one example, the materials of the transducer elements include a 1-3 type piezocomposite material.

The damping component 260 can comprise materials that prevent propagation of acoustic waves from the transducer elements 270 into the housing component 262. These materials help to focus the acoustic waves in the direction of the target to maximize the amount of energy the acoustic waves carry into the target. This feature improves penetration of the acoustic waves, thus improving the robustness of the probe device 200 to achieve better and/or more detail interrogation of targets with cross-sections of substantial thickness.

The transducer section 266 of the damping component 260 can arrange the transducer elements 270 to achieve the profiles 236, 238 of the transducer arrays 208, 210. The transducer section 266 can have a convex shape, for example, that extends generally upwardly away from the housing component 260 along the centerplane 230. The amount of curvature of the convex shape positions the transducer elements 268 and define the profiles 236, 238 of the transducer arrays 208, 210.

FIG. 6 depicts a detail view of the probe device 200 to illustrate in more detail one configuration of the transducer section 266 with the transducer elements 270 disposed thereon. In the example of FIG. 5, the probe device 200 includes a first transducer element 272 and a second transducer element 274 disposed in adjacent relationship to the first transducer element 272 and separated by a gap 276. The transducer elements 272, 274 mount to the upper surface 264 of the damping component 260. In one example, the transducer elements 272, 274 form a transducer angle (e.g., a first transducer angle 278 and a second transducer angle 280) with a plane 282 tangent to the outer surface 264 of the damping component 260 and perpendicular to the centerplane 230.

As shown in FIG. 6, the first transducer angle 278 and the second transducer angle 280 are different and, in a more particular example, the second transducer angle 280 is larger than the first transducer angle 278. This arrangement of the transducer elements 272, 274 defines the profiles 236, 238 of the transducer arrays 208, 210. As discussed above, the shape of the profiles 236, 238 set out the position of the transducer elements 272, 274 to determine the steering angle of the probe device 200. The arrangement and geometry for the various components can be selected to achieve the desired angular range (e.g., angular range 140 of FIGS. 3 and 4). In one embodiment, the position of the transducer elements 272, 274 can be determined according to one or more of the Equations (1) and (2) below,

$$\begin{matrix}{X}_{C , i} = \frac{{x}_{i} + {x}_{i - 1}}{2} & ( 1 ) \\ {Y}_{C , i} = \frac{{y}_{i} + {y}_{i - 1}}{2} & ( 2 )\end{matrix}$$

wherein, X_{C,I} and Y_{C,I} are coordinates for the center point of the transducer elements 272, 274 and xᵢ and yᵢ are coordinates for the outer extremities of the transducer elements and, in one example, a point on the transducer elements 272, 274 that is closest to the centerplane 230. The values for xᵢ and yᵢ can be calculated using one or more of the Equations (3), (4), (5), (6), (7), and (8) below,

αₒ=Δ₁ (3)

α₁=α₀+Δ₂ (4)

x₀=x₀ (5)

Y₀=y₀ (6)

x₁=x₀−p cos α₁ (7)

Y₁=y₀−p sin α₁ (8)

wherein, αₒ is transducer angle 278, α₁ is transducer angle 276, x₀ and y₀ are coordinates for a point on the first transducer 272, x₁ and y₁ are coordinates for a point on the second transducer 274, Δ₁ and Δ₂ are increments that are selected to minimize the deviation angle from the acoustic axis of the transducer elements 272, 274, and p is the pitch of the transducers equal, in one example, to the sum of the width of adjacent transducers 272, 274 and the gap 276 between adjacent transducers 272, 274.

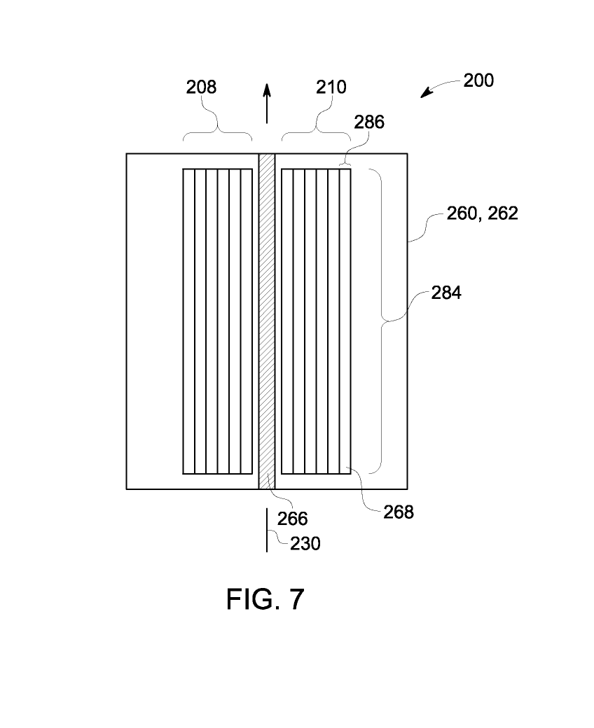

FIG. 7 depicts a plan view of the probe device 200 taken at line 7-7 of FIG. 5. One or more dimensions (e.g., a first dimension 284 and a second dimension 286) describe the form of the transducer elements 270. In the example of FIG. 5, the dimensions 284, 286 define elongated rectangular components that are disposed adjacent one another to form the transducer arrays 208, 210. In other examples, the dimensions 284, 286, can define a series of square components for the transducer elements 270 that form a grid.

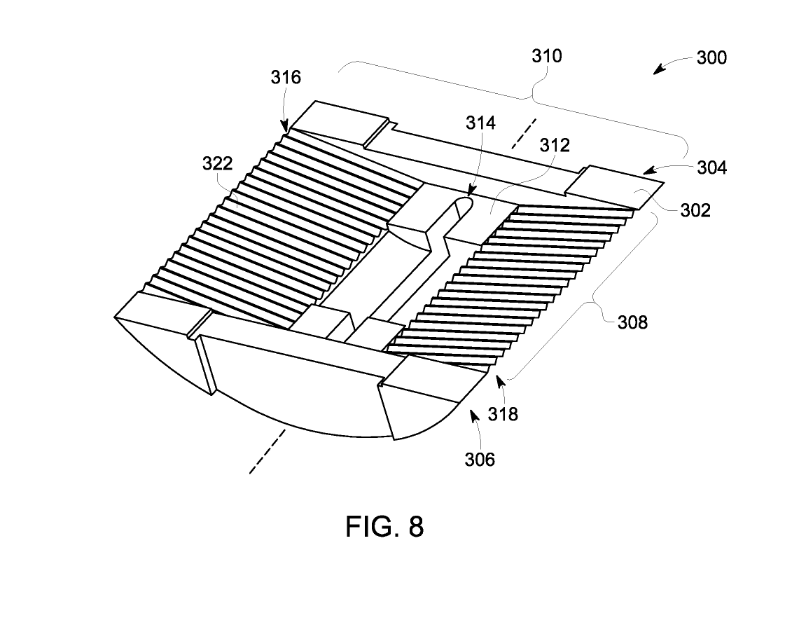

FIG. 8 depicts a perspective view of an example of a wedge component 300 for use with a probe device (e.g., probe devices 100, 200 of FIGS. 1, 2, 3, 4, 5, 6, and 7). Examples of the wedge component 300 can comprise materials with properties that comport with conduction of acoustic waves. Suitable materials can exhibit conduction rates of about 2360 m/s or greater. Examples of these materials include plastics, e.g., plexiglass and Rexolite®. In the example of FIG. 8, the wedge component 300 has a body 302 with a first side 304 and a second side 306 that bound a central region 308. In the central region 308, the body 302 has a generally curvilinear inner profile 310 that terminates at a planar surface 312. An elongated slot 314 extends disposed on the planar surface 312 along a longitudinal axis 316. Examples of the elongated slot 314 may penetrate through the material of the body 302. The body 302 also has one or more contoured sections (e.g., a first contoured section 316 and a second contour section 318). A plurality of facets 320 populate the contoured sections 316, 318. Examples of the facets 320 can have shapes that can enhance conduction of acoustic waves, e.g., during operation of the probe device.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An ultrasonic probe, comprising:
a base component with a centerplane;
a transducer assembly disposed on the base component, the transducer assembly comprising a first transducer array and a second transducer array residing on either side of the centerplane of the base component; and
a wedge component coupled with the base component in position to receive acoustic waves from the first transducer array and the second transducer array, the wedge component having an outer surface with a non-linear shape.

2. The probe device of claim 1, wherein the first transducer array and the second transducer array have a first end proximate the centerplane and a second end spaced apart from the first end, and wherein the second end is below the first end relative to and along the centerplane.

3. The probe of claim 1, wherein the first transducer array and the second transducer array have, respectively, a first profile and a second profile, and wherein the first profile and the second profile have an arcuate shape.

4. The probe device of claim 3, wherein the base component comprises a housing and a damping component disposed on the housing, wherein the damping component has an upper surface that has a transducer section that supports the first transducer array and the second transducer array, and wherein the upper surface in the transducer section extends generally upwardly from the along the centerplane to position the first transducer array and the second transducer array in, respectively, the first profile and the second profile.

5. The probe device of claim 1, wherein the first transducer array and the second transducer array are adapted to generate shear waves and compression waves.

6. The probe device of claim 1, wherein the first transducer array and the second transducer array comprise a first transducer element proximate the centerplane and a second transducer element that is adjacent to the first transducer element.

7. The probe device of claim 6, wherein the first transducer element and the second transducer element have an elongated rectangular shape.

8. The probe device of claim 6, wherein the first transducer element and the second transducer element have a square shape.

9. The probe device of claim 6, wherein the first transducer element has a first transducer angle and the second transducer element has a second transducer angle that is different from the first transducer angle.

10. The probe of claim 1, wherein the wedge component comprises a material having a conduction rate for acoustic waves of about 2360 m/s or greater.

11. A probe for detecting an anomaly in a target, said probe comprising:
a base component having a first surface and a centerplane;
a first transducer element disposed on the first surface proximate the centerplane and at a first transducer angle relative to a plane that is tangent to the first surface and perpendicular to the centerplane; and
a second transducer element adjacent to the first transducer and disposed on the first surface at a second transducer angle relative to the plane and perpendicular to the centerplane,
wherein the first transducer angle is different from the second transducer angle.

12. The probe of claim 11, further comprising a wedge component in position to receive acoustic waves from the first transducer element and the second transducer element, the wedge component having an outer surface with a non-linear shape that curves away from the first transducer element and the second transducer element.

13. The probe of claim 11, wherein the first transducer element and the second transducer element have dimensions that define an elongated rectangular shape.

14. The probe of claim 11, wherein the second transducer angle is larger than the first transducer angle.

15. A system, comprising:
a probe device comprising a base component with a centerplane, a first transducer array disposed on the base component on a first side of the centerplane, a second transducer array disposed on the base component on a second side of the centerplane, and a wedge component mounted to the base component in position to receive acoustic waves from the first transducer array and the second transducer array; and
a test instrument adapted to exchange signals that energize the first transducer array and the second transducer array to generate the acoustic waves,
wherein the first transducer array, the second transducer array, and an outer surface of the wedge component have a profile with a non-linear shape.

16. The system of claim 15, where the first transducer array and the second transducer array have a first end proximate the centerplane and a second end spaced apart from the first end, and wherein the non-linear shape of the first transducer array and the second transducer array positions the second end below the first end relative to and along the centerplane.

17. The system of claim 15, wherein the outer surface of the wedge component curves away from the first transducer array and the second transducer array relative to and along the centerplane.

18. The system of claim 15, wherein the first transducer array and the second transducer array comprise a first transducer element and a second transducer element adjacent to the first transducer element, and wherein the non-linear shape positions the first transducer element and the second transducer element at, respectively, a first transducer angle and a second transducer angle relative to a plane that is tangent to surface of the base component and perpendicular to the center plane, and wherein the second transducer angle is larger than the first transducer angle.

19. The system of claim 15, wherein the wedge component comprises a material having a conduction rate for acoustic waves of about 2360 m/s or greater.

20. The system of claim 15, wherein the test instrument is adapted to vary the signal to cause the first transducer array and the second transducer array to generate acoustic waves as shear waves and compression waves.
